(19) United States
(12) Patent Application Publication
(10) Pub. No.: US 2009/0314409 A1
(43) Pub. Date: Dec. 24, 2009

(54) Apparatus and Method of Reinforcing a Conduit or Vessel

(76) Inventor: Mohammad R. Ehsani, Tucson, AZ (US)

Correspondence Address: QUICKPATENTS, INC., 32861 CALLE PERFECTO, SUITE A, SAN JUAN CAPISTRANO, CA, 92675, US

(21) Appl. No.: 12/233,849

(22) Filed: Sep. 19, 2008

Related U.S. Application Data
(60) Provisional application No. 61/132,311, filed on Jun. 18, 2008.

(51) Int. Cl. B29C 65/52; D03D 15/00

(52) U.S. Cl. 156/60; 442/182

(57) ABSTRACT

A web for reinforcing the wall of a vessel or conduit, and methods of installation therein, is disclosed. The vessel or conduit is any structure that has a concave or arched inner surface. The web is comprised of an elongated composite laminate that has a fabric layer with a plurality of fibers embedded into a cured resin matrix. When cured on a curing surface, the composite laminate retains an elastic memory of the curing surface such that the composite laminate is substantially self-supporting against the inside surface of the wall due to its elastic memory. In use, a tack coat of epoxy with viscosities ranging from low to high, or gel epoxy, is applied to at least a portion of the bottom side of the laminate, which is then applied to the inside surface of the wall so as to reinforce the wall. Multiple such composites may be applied to the wall in turn in a ring pattern or in a spiral pattern, overlapping at least one recently applied composite to form a water-tight seal within the conduit and to reinforce the conduit.

### CROSS-REFERENCE TO RELATED APPLICATIONS

This application claims the benefit of U.S. Provisional Patent Application 61/132,311, filed on Jun. 18, 2008, and incorporated herein by reference.

### STATEMENT REGARDING FEDERALLY SPONSORED RESEARCH AND DEVELOPMENT

Not Applicable.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### FIELD OF THE INVENTION

This invention relates to pipelines, and more particularly to improved pipeline reinforcement devices and methods.

### DISCUSSION OF RELATED ART

There are many methods for lining a pipe with a water-tight layer to prevent the leakage of fluids, such as when such pipes need to be repaired or refurbished. One such method is disclosed in U.S. Pat. No. 7,270,150 by Warren on Sep. 18, 2007. Another method is disclosed in U.S. Pat. RE35944 by Driver, et al. on Nov. 3, 1998. These methods utilize internal pressure from air or a liquid to expand a liner inside of the pipe in a way that the liner will adhere to the inside surface of a pipe. However, the liners that are specified, e.g. felt, are only intended to be resin-absorbing media, such that the liners absorb relatively large quantities of resins. There is no mention of strengthening a pipe in any of these patents, nor will the mixture of felt and resin provide any substantial strength to the pipe.

Another prior art method, taught in U.S. Pat. 5,931,198 to Raji and Fyfe., describes the strengthening of pipes with carbon fabric saturated with resin. In such a method, workers transport fibrous layers into the pipe, affix them to the inside of the pipe, and then soak the layers with resin that eventually cures to form the reinforcement. Alternately, “pre-formed” sections are soaked with resin and transported into the pipe. Such a method requires multiple pieces of “pre-formed” sections to be spliced together at the seams within the pipe using lap splice pieces of fabric impregnated with resin. Further, such pre-formed sections must be small enough to fit within a small pipe opening, such as a manhole, but it is not clear how this is to be accomplished in the —198 patent with relatively long strips of composite reinforcement material, particularly with cured “pre-formed” sections. As such, the “pre-formed” sections must necessarily be relatively short. In fact, recently Fibrwrap Construction, an affiliate of Fyfe was granted a contract (Project #070637.1) by Sky Engineering (Phoenix, Ariz.) to retrofit two large-diameter pipes in Tristate Power Generation Plant (Craig, Colo.). The design provided by the consulting firm of SGH (Waltham, Mass.) required application of two layers of carbon fabric to the inside surface of the pipes and the project was carried out in March and April 2008. In spite of extreme cold temperatures (−6 degrees Fahrenheit) and the time constraints imposed by the plant, Fibrwrap Construction saturated the carbon fabrics outside of the pipe and carried the fabric into the pipe, applying the wet fabric one layer at a time and waiting for it to cure in place. As discussed herein, the current invention offers significant advantages over Raji and Fyfe.

Other pipe reinforcement methods are disclosed in Fawley's Patents: U.S. Pat. No. 5,683,530 on Nov. 4, 1997; U.S. Pat. No. 5,677,046 on Oct. 14, 1997; U.S. Pat. No. 4,559,974 on Dec. 24, 1985; and U.S. Pat. No. 5,632,307 on May 27, 1997. Such methods contemplate utilizing composite reinforcing strips on the outside surface of the pipe, however, and make no provision for use inside a pipe or vessel.

Therefore, there is a need for a method that facilitates the reinforcing of pipes from the inside. Such a needed method would result in a reinforcement of the pipe that is substantially water-tight along its length, strong, light-weight, relatively easy-to-install, and that can be installed quickly, reducing down-time of the pipe. The composite reinforcement material of the needed method would be easy to fabricate, even when necessitating customization, easy to transport and handle, light-weight, and easy-to-place within the pipe. The present invention accomplishes these objectives.

### SUMMARY OF THE INVENTION

The present device is a web or a laminate for reinforcing the wall of a vessel or conduit. The vessel or conduit is any structure that has a concave or arched inner surface, such as a water pipe, sewer pipe, water tank, petroleum tank, silo, or the like. The web is comprised of an elongated composite laminate that has a fabric layer with a plurality of fibers embedded into a cured resin matrix. Further, the resin may be selected depending on the intended environment where the web will be installed, for example a resin that is safe for contact with potable water or a resin with high resistance to chemicals such as H₂S gas that is present in sewer pipes.

When cured on a curing surface, the composite laminate retains an elastic memory of the curing surface such that the composite laminate is substantially self-supporting against the inside surface of the wall due to its elastic memory. Further, the curing surface may have a rough surface formed therein, such that a bottom side of the composite laminate is formed into a rough surface for relatively strong adhering with a tack coat or an epoxy with any viscosity including gel epoxy.

In use, the tack coat is applied to at least a portion of the bottom side of the laminate, which is then applied to the inside surface of the wall so as to reinforce the wall. Multiple such composites may be applied to the wall in turn in a ring pattern or in a spiral pattern, overlapping at least one recently applied composite to form a water-tight seal within the conduit and to reinforce the conduit.

The laminate is preferably less than 50 mils thick so that it can be readily rolled into a coiled configuration, and can be made to any desired length and width suitable for the diameter of the vessel or conduit. A retaining strap may be further included and applied to the laminate when the laminate is rolled into the coiled configuration. Preferably, each laminate is introduced proximate the inside surface of the wall in its coiled configuration, facilitating installation within a pipe that has an access aperture formed therein, for example. As such, once the laminate is released from its coiled configuration by removing the retaining strap, the tack coat may be applied to the laminate and applied to the inside surface of the wall, the laminate is substantially self-supporting against the inside surface of the wall due to its elastic memory. Additionally, fasteners such as screws, rivets, nails, bolts, etc. can be used to secure the overlapping regions of the laminate or to secure the laminate to the walls of the vessel. The laminate may be of a length that wraps around the inside surface of the vessel or conduit several times, whereupon the next laminate may be applied in turn.

The present method facilitates the reinforcing of pipes from the inside and results in a reinforcement of the pipe that is substantially water-tight along its length, strong, light-weight, relatively easy-to-install, and that is installed quickly, reducing down-time of the pipe. The composite laminate material of the present method is easy to fabricate, even when customization is required. Further, the composite laminate of the present method is easy to transport and handle, light-weight, and easy-to-place within the pipe. The present invention further provides a safe barrier within a pipe or vessel that has a contaminating substance therein, such as lead paint for example. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of a composite laminate of the invention;

FIG. 2 is a perspective view of the composite laminate as cured on an arched curing surface;

FIG. 3 is a perspective view of the composite laminate in a coiled configuration;

FIG. 4 is a perspective view of a plurality of the composite laminates as applied to the inside surface of a pipe;

FIG. 5 is a cross-sectional view of the invention, taken generally along lines 5-5 of FIG. 4, and illustrating a ringed pattern;

FIG. 6 is a cross-sectional view of the invention, taken generally along lines 5-5 of FIG. 4, and illustrating a spiral pattern;

FIG. 7 is an enlarged cross-sectional view of the invention as while being applied to the inside surface of the pipe;

FIG. 8 is a partial top plan view of the composite laminate, illustrating both longitudinally-aligned fibers and cross-linking fibers of a fabric layer thereof,

FIG. 9 is a diagram of a manufacturing process of the composite laminate; and

FIG. 10 is an enlarged cross-sectional view of the composite laminate, taken generally along lines 10-10 of FIG. 9.

### DETAILED DESCRIPTION OF THE PREFERRED EMBODIMENT

Illustrative embodiments of the apparatus and method of reinforcing a conduit or vessel are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

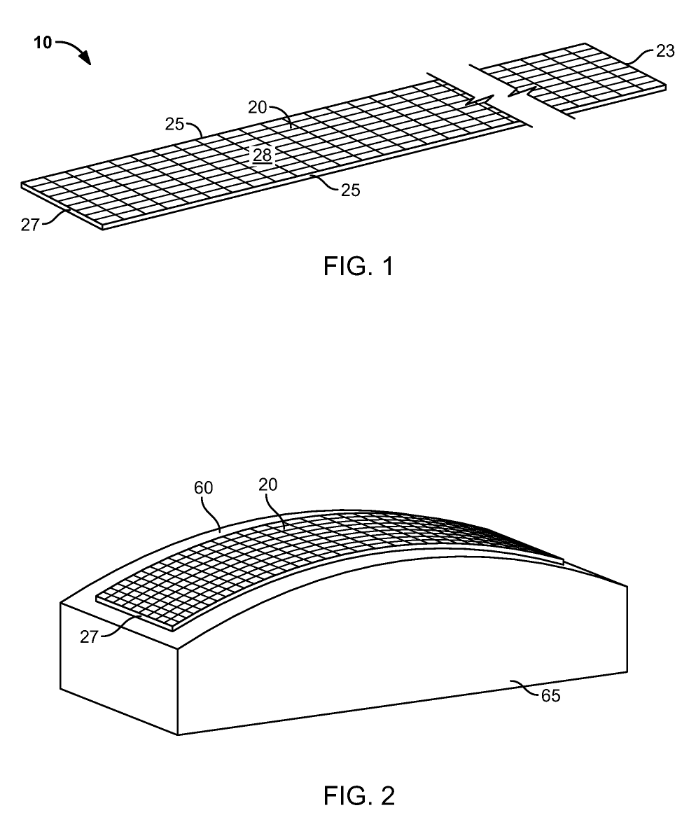

FIG. 1 illustrates a web 10 for reinforcing the wall 15 of a vessel or conduit 16. The vessel or conduit 16 is any structure that has a concave or arched inner surface 17, such as a water pipe, water tank, sewer pipe, petroleum tank, silo, or the like.

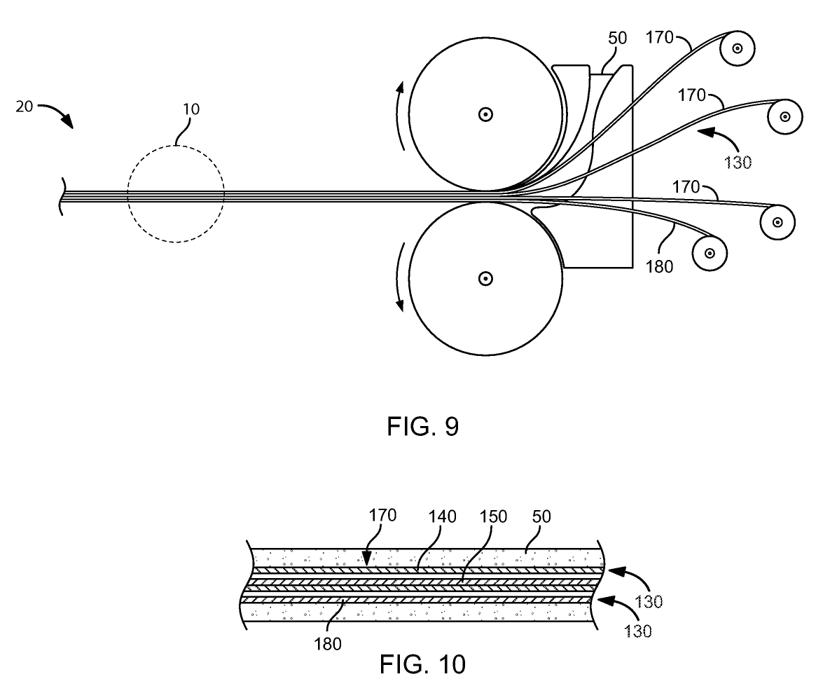

The web 10 is comprised of an elongated composite laminate 20 that has a fabric layer 130 with a plurality of fibers 35 embedded into a cured resin matrix 50 (FIGS. 8 and 9). Such resin may include epoxy, polyester, urethane, a combination thereof, or the like. Such resin may also be selected based on the intended application in the field; for example, a non-toxic resin may be used for applications involving potable water pipes and tanks 16, or a chemical resistant resin may be selected when chemicals are present, such is in sewer pipes or pipes and tanks 16 containing petroleum or other chemicals. Moreover, a resin may be selected that acts as a barrier to contaminants within the pipe or tank 16, such as lead paint, or the like. The fibers 35 saturated with the resin may pass through rollers or a press (FIG. 9) and may be subjected to heat to harden and cure the laminate. Once cured, the composite laminate 20 has a top side 28, an opposing bottom side 22, one end 27 and an opposing other end 23, and two opposing side edges 25. The side edges 25 may be trimmed after curing to reduce sharp and irregular areas.

When cured on a curing surface 60 of a form 65 (FIG. 2), the composite laminate 20 retains an elastic memory of the curing surface 60. Preferably the curvature along a length of the curing surface 60 is less than or equal to the curvature of the inside surface 17 of the wall 15, such that the composite laminate 20 is substantially self-supporting against the inside surface 17 of the wall 15 due to its elastic memory. Alternately, the curing surface 60 may be relatively planar (FIG. 1). Further, the curing surface 60 may have a rough surface 161 formed therein, such that the bottom side 22 of the composite laminate 20 is formed into a rough surface 160 for relatively strong adhering with a tack coat 90, such as an epoxy resin, contact cement or the like, that may be applied thereto. Alternately, the rough surface 161 may be formed into bottom side 22 of the composite laminate 20 by applying a peel-off material (not shown) that, upon peeling, creates the rough surface 161. Such peel-off materials are well known in the art. Alternatively, the bottom side 22 may be coated with an epoxy adhesive and protected by a peel-off material (not shown) that can be removed prior to installation of the laminate 20 on the walls 15 of the vessel 16, thus eliminating the need for the application of tack coat 90 in the field. The top side 28 of the composite laminate 20 is preferably smooth so as to reduce friction with any substances flowing within the conduit 16. In this manner each laminate 20 may be formed and cured in a controlled environment away from the installation location. Transporting each laminate 20 to the installation location is relatively easy as each laminate 20 is preferably made from lightweight resin and fiber materials.

Preferably the fabric layer 130 is a woven fabric 140 and the plurality of fibers 35 of the fabric layer 140 are substantially coaligned high tensile strength longitudinally-aligned fibers 30 (FIG. 8) extending substantially continuously along the length of the laminate 20. The fabric layer 130 also preferably includes a plurality of transverse, cross-linking fibers 40 extending along the width of the laminate and are at least partially threaded between the longitudinally-aligned fibers 30. Alternately the fabric layer 130 is a stitched fabric 150. The ratio of longitudinally-aligned fibers to cross-linking fibers preferably is within the range of 100:1 to 1:100.

In one embodiment of the invention, the fabric layer 130 includes a plurality of fabric sheets 170 (FIG. 9). In such an embodiment, the bottom-most fabric sheet 170 may be a corrosion-resistant glass fabric sheet 180. Each fabric sheet 170 may be made of glass, carbon, aramid (Kevlar®), ceramic, polyethylene, or other suitably strong materials, including high strength steel wires.

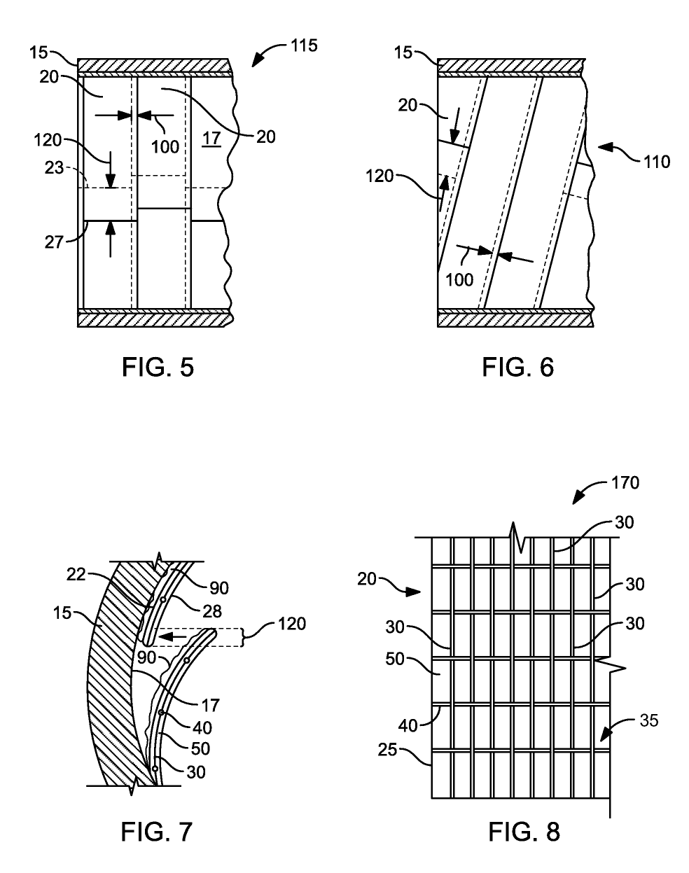

In use, the inside surface 17 may optionally be prepared first by filling cracks, cleaning, or the like. The tack coat 90 is then applied to at least a portion of the bottom side 22 of the laminate 20, which is then applied to the inside surface 17 of the wall 15 so as to reinforce the wall. Multiple such composites 20 may be applied to the wall 15 in turn in a ring pattern 115, such that the one end 27 of each composite 20 overlaps the other end 23 of the composite 20 (FIG. 5) by an overlap distance 120, typically 6 to 12 inches. Each successive laminate 20 preferably overlaps the previously-applied laminate 20 by a lateral overlap distance 100, typically 2 to 12 inches. As such, laminates 20 are preferably applied successively upstream from the normal flow of liquid in the pipe or conduit 16, so that the exposed side edge 25 of each laminate 20 faces downstream so as to not create unnecessary fluid turbulence within the pipe or conduit 16 and to prevent the fluid from getting between any laminate 20 and the pipe or conduit 16.

In an alternate application method, multiple composites 20 may be applied to the wall 15 in turn in a spiral pattern 110, such that the one end 27 of each composite 20 does not overlaps the other end 23 of the composite 20, but such that one side edge 25 does at least partially overlap the opposing side edge 25 (FIG. 6) by the distance 100, typically 2 to 12 inches.

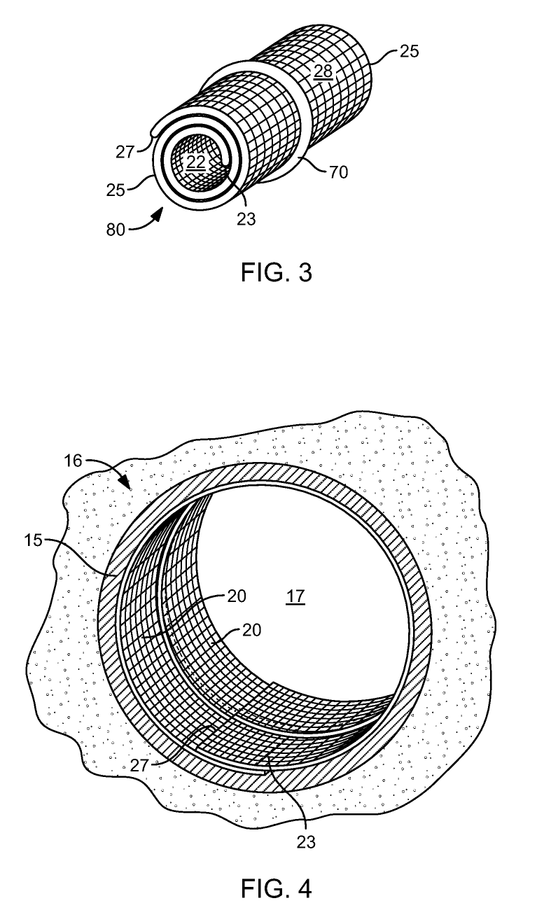

The laminate 20 is preferably less than 50 mils thick so that it can be readily rolled into a coiled configuration 80 (FIG. 3), and can be made to any desired length and width suitable for the diameter of the vessel or conduit 16. For example, a laminate 20 may be hundreds of feet in length, and typically between 24 to 50 inches in width, and rolled into a coil configuration 80 having a diameter of not more than 30 inches. A retaining strap 70 may be further included and applied to the laminate 20 when the laminate 20 is rolled into the coiled configuration 80. Preferably, each laminate 20 is introduced proximate the inside surface 17 of the wall 15 in its coiled configuration 80, facilitating installation within a pipe 16 that has an access aperture (not shown) formed therein having a large enough opening to allow easy passage of the coiled laminate 80, for example. As such, once the laminate 20 is released from its coiled configuration 80 by removing the retaining strap 70, the tack coat 90 may be applied to the laminate 20 and applied to the inside surface 17 of the wall 15, the laminate is substantially self-supporting against the inside surface 17 of the wall 15 due to its elastic memory. The laminate 20 may be of a length that wraps around the inside surface 17 of the vessel or conduit 16 several times, whereupon the next laminate 20 may be applied in turn.

In another embodiment of the invention, a film (not shown) of adhesive resin or epoxy can be applied to the bottom side 22 of the laminate 20 and covered with a protective peel-off sheet (not shown) to facilitate rolling of the web into the coiled configuration 80 for storage and transportation. During the installation of the laminate 20 in the field, the peel-off sheet may be peeled off, exposing the adhesive on the bottom side 22 of the laminate 20. The laminate 20 may then be directly applied to the wall 15 of the vessel 16.

While the above embodiments mention the use of adhesives and resins to bond the laminate 20 to the wall 15 of the vessel 16, other fastening means including but not limited to screws, bolts, rivets, nail, and the like may also be used to attach the laminate 20 to the wall 15 of the vessel 16 and to provide more permanent bonding between the overlapping regions 100 and 120 of the laminate 20. It is also envisioned that a combination of adhesives, resins, epoxies and fasteners can be used to adequately attach the laminate 20 to the vessel 16.

In yet another embodiment, the laminate 20 need not be fully secured to the vessel 16 at all points of contact therewith. For example, when the goal of a particular installation is to provide a leak-proof liner, rather than a structural strengthening system, for a sewer or water pipe, for example, the laminate 20 can be assembled in individual overlapping rings (FIG. 5) or as a continuous overlapping spiral with occasional points of attachment to the pipe 16 along the length of the pipe 16 (FIG. 6). The laminate 20, once installed and cured, will provide a water-tight pipe within the pipe to eliminate or reduce leakage. The intent of securing the laminates 20 to various contact points within the pipe 16 is to ensure that the assembled laminates 20 stay in place and do not tend to move downstream once the pipe 16 is again in use.

### DESIGN EXAMPLES

The selection of the type of fiber 35, its orientation (longitudinal vs. transverse) and the volume of the fibers 35 to construct the web or laminate 20 may depend on the level of force or pressure that the vessel 16 will be subjected to, as the laminate 20 in conjunction with the current strength of the vessel 16 are intended to become a strong enough vessel 16 to resist the applied loads. Three illustrative examples are given below; other cases of loading can be designed, using the instant invention, by those skilled in the art. In the first two examples, the laminate 20 is placed in ring arrangement as shown in FIG. 5. In the third example, a continuous spiral as shown in FIG. 6 is used.

### Example 1

It is assumed that a concrete pipe 16 having an internal diameter of D=60 inches is subjected to an internal pressure of 25 psi. It is further assumed that considering factors of safety, the pipe 16 has to be designed to withstand a pressure of p=50 psi. It is further assumed that due to corrosion and other damage, the strength of the pipe 16 has diminished so much that it can be negligible, so that the new web 10 must resist the entire pressure of 50 psi. Using the relationships known to those skilled in design of pressure vessels, the force in the hoop direction is given by:

T=p D/2=50 psi*(60 inch)/2=1500 pounds per inch length of the pipe 16.

Assuming that the pipe 16 is being strengthened with laminates 20 placed inside the pipe 16 in the hoop direction (not spirally), the force of 3000 pounds is resisted by the fibers 30 positioned along the longitudinal direction of the laminate 20. Thus a laminate 20 with a minimum strength of 1500 pounds per inch width of the laminate 20 must be used. In this example, the length of the overlap 120 at the end of the band of laminate 20 must be large enough to allow the development of the full laminate 20 capacity, 1500 pounds in this example. If, for example, the strength of the web is 800 pounds per inch width, then two layers of the laminate 20 must be applied to the pipe 16 to provide a resisting force of 2*800=1600 pounds which is greater than the required 1500 pounds.

### Example 2

Assume that the pipe 16 of Example 1 is further subjected to axial forces such that a force of 200 pounds per inch is required along the axis of the pipe 16. This force could be due to flexural bending of the pipe, for example. In this case, the web 10 is constructed such that the longitudinal fibers 30 provide the previously-given strength of 1500 pounds per inch width of laminate 20 and the cross-linking or transverse fibers 40 provide a strength of 200 pounds per inch width of laminate 20 laterally. In placement of each laminate 20 for this example, the overlap 100 along the length of the pipe 16 must be large enough to allow the development of 200 pounds per inch of laminate 20. Similar to Example 1, the overlap 120 at the end of the band must also be large enough to allow the development of 1500 pounds per inch width of the web 10.

### Example 3

Assume that the pipe 16 of Example 1 is to be reinforced with a web 10 that has most of its fibers 35 oriented along the longitudinal axis. Each laminate 20 is assumed to be w=50 inches wide and installed on the pipe surface 15 in a spiral manner (FIG. 6) with an overlap length 100 of m=4 inches wide. The orientation of each laminate 20 results in a small reduction in the effective forces in the hoop direction. The efficiency factor can be calculated as:

R=πD/√[S²+(πD)²]

where S=w−m=50−4=46 inches.

This results in R=0.97, which means that in order to achieve a 1500 pounds per inch strength in the hoop direction, the web 10 must have a strength along its longitudinal axis at least equal to 1500/0.97=1544 pounds per inch width.

While a particular form of the invention has been illustrated and described, it will be apparent that various modifications can be made without departing from the spirit and scope of the invention. For example, while rectangular laminates 20 are illustrated, other shapes of the laminates 20 could be used to, for example, facilitate the application thereof to an intersections of pipes 16, or the like. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A web for reinforcing the wall of a vessel or conduit, the wall having an arched inside surface, the web comprising:
an elongated composite laminate having a fabric layer with a plurality of fibers, all of the fibers embedded into a cured resin matrix to form the web, the web having a top side, an opposing bottom side, one end and an opposing other end, and two opposing side edges, the composite laminate when cured on a curing surface retaining an elastic memory of the curing surface.

2. The web of claim 1 wherein the fabric layer is a woven fabric and wherein the plurality of fibers of the fabric layer are substantially coaligned high tensile strength longitudinally-aligned fibers extending substantially continuously along the length of the laminate, and further include a plurality of cross-linking fibers extending along the width of the laminate and at least partially threaded between the longitudinally-aligned fibers.

3. The web of claim 1 wherein the fabric layer is a stitched fabric.

4. The web of claim 1 wherein the curing surface includes a curvature along a length thereof less than or equal to the curvature of the wall, such that the composite laminate is substantially self-supporting against the inside surface of the wall due to its elastic memory.

5. The web of claim 1 wherein the curing surface is relatively planar, such that the composite laminate is substantially self-supporting against the inside surface of the wall due to its elastic memory.

6. The web of claim 1 wherein the laminate is less than 50 mils thick.

7. The web of claim 2 wherein the proportion of longitudinally-aligned fibers to cross-linking fibers is at least 100:1.

8. The web of claim 2 wherein the proportion of cross-linking fibers to longitudinally-aligned fibers is at least 100:1.

9. The web of claim 1 further including a retaining strap, whereby when the composite laminate is rolled into a coiled configuration the retaining strap may be applied to the laminate to retain the laminate in the coiled configuration until the retaining strap is removed.

10. The web of claim 1 wherein the bottom side of the laminate is substantially smooth.

11. The web of claim 1 wherein the bottom side of the laminate includes a rough surface that provides increased surface area to which the tack layer may bond.

12. The web of claim 1 wherein the fabric layer includes a plurality of fabric sheets.

13. The web of claim 12 wherein at least one of the fabric sheets is a corrosion-resistant glass fabric sheet.

14. A method for reinforcing a wall of a vessel or conduit, the wall having a concave inside surface, comprising the steps of:
a) providing the web of claim 1;
b) applying a tack coat to at least a portion of the bottom side of the web; and
c) applying the bottom side of the web to the inside surface of the wall to reinforce the wall.

15. A method for reinforcing a wall of a vessel or conduit, the wall having a concave inside surface, comprising the steps of:
a) providing a plurality of the webs of claim 1;
b) applying a tack coat to at least a portion of the bottom side of a first-applied web;
c) applying the bottom side of the first-applied web to the inside surface of the wall;
d) applying a tack coat to at least a portion of the bottom side of a next-applied web;
e) applying the bottom side of the next-applied web to the inside surface of the wall, overlapping at least a portion of a previously-applied web therewith; and
f) repeating from step d) until the wall is reinforced.

16. The method of claim 15 wherein step c) is replaced with
c′) applying the bottom side of the first-applied web to the inside surface of the wall such that the one end of the first-applied web substantially overlaps the other end thereof,
and wherein step e) is replaced with
e′) applying the bottom side of the next-applied web to the inside surface of the wall, overlapping at least a portion of the side edge of a previously-applied web therewith and such that the one end of the next-applied web substantially overlaps the other end thereof.

17. The method of claim 15 wherein step c) is replaced with
c′) applying the bottom side of the first-applied web to the inside surface of the wall in a spiral pattern such that the one end of the first-applied web does not substantially overlap the other end thereof;
and wherein step e) is replaced with
e′) applying the bottom side of the next-applied web to the inside surface of the wall in the spiral pattern, overlapping at least a portion of the side edge of the previously-applied web therewith and such that the one end of the next-applied web does not substantially overlap the other end thereof.

18. A method for reinforcing a wall of a vessel or conduit, the wall having a concave inside surface, comprising the steps of:
a) providing the web of claim 9;
b) removing the retaining strap from the coiled web;
c) applying a tack coat to at least a portion of the bottom side of the web; and
d) applying the bottom side of the web to the inside surface of the wall to reinforce the wall.

19. A method for reinforcing a wall of a vessel or conduit, the wall having a concave inside surface, comprising the steps of:
a) providing a plurality of the webs of claim 9 to the vicinity of the inside surface of the wall;
b) removing the retaining strap from a first-applied web;
c) applying a tack coat to at least a portion of the bottom side of the first-applied web;
d) applying the bottom side of the first-applied web to the inside surface of the wall;
e) removing the retaining strap from a next-applied web;
f) applying a tack coat to at least a portion of the bottom side of the next-applied web;
g) applying the bottom side of the next-applied web to the inside surface of the wall, overlapping at least a portion of a previously-applied web therewith; and
h) repeating from step e) until the wall is reinforced.

20. The method of claim 19 wherein step d) is replaced with
d′) applying the bottom side of the first-applied web to the inside surface of the wall such that the one end of the first-applied web substantially overlaps the other end thereof,
and wherein step g) is replaced with
g′) applying the bottom side of the next-applied web to the inside surface of the wall, overlapping at least a portion of the side edge of a previously-applied web therewith and such that the one end of the next-applied web substantially overlaps the other end thereof.

21. The method of claim 19 wherein step d) is replaced with
d′) applying the bottom side of the first-applied web to the inside surface of the wall in a spiral pattern such that the one end of the first-applied web does not substantially overlap the other end thereof;
and wherein step g) is replaced with
g′) applying the bottom side of the next-applied web to the inside surface of the wall in the spiral pattern, overlapping at least a portion of the side edge of a previously-applied web therewith and such that the one end of the next-applied web does not substantially overlap the other end thereof.
